(19) United States
(12) Patent Application Publication
(10) Pub. No.: US 2009/0121477 A1
(43) Pub. Date: May 14, 2009

(54) Conduit Having a Variable Rigidity

(76) Inventor: Olivier Pradeilles, Mons (FR)

Correspondence Address: LUCAS & MERCANTI, LLP, 475 PARK AVENUE SOUTH, 15TH FLOOR, NEW YORK, NY, 10016, US

(21) Appl. No.: 11/815,948

(22) PCT Filed: Jan. 18, 2006
(86) PCT No.: PCT/FR06/00107

§ 371 Date: Aug. 9, 2007

Related U.S. Application Data
(60) Provisional application No. 60/665,444, filed on Mar. 25, 2005.

(30) Foreign Application Priority Data
Feb. 15, 2005 (FR) 0501494
Apr. 29, 2005 (FR) 0504341

(51) Int. Cl. F16L 11/18

(52) U.S. Cl. 285/146.1

(57) ABSTRACT

The present invention relates to a flexible pipe adapted in particular for transporting fluids or powder materials, the pipe comprising at least one leaktight and flexible tube within which a said fluid or a said material can be conveyed, the pipe comprising a clamping device covering said leaktight tube over at least a fraction of the length of said pipe, preferably over all of said pipe, said clamping device comprising at least one sheath and clamping means for clamping said sheath, said sheath and said clamping means being adapted, at rest, to preserve the pliability and the flexibility of said pipe, and when a determined stress is applied, to stiffen said pipe and freeze its position over the length of said pipe covered by said clamping device. An actuator for such a pipe is also proposed by the present invention.

The present invention relates to a flexible pipe adapted in particular to transporting liquid or gaseous fluids or indeed powder materials, said pipe including a clamping device enabling its flexibility to be reduced so as to be able to stiffen and “freeze” the pipe, and vice versa, depending on the requirements inherent to the use being made of said pipe. The invention also relates to an actuator for actuating such a variable-stiffness pipe.

### BACKGROUND OF THE INVENTION

The pipe of the invention can be used for a variety of purposes such as, for example, a shower hose, a fire hose, a watering hose, or any other application for transporting liquid or gaseous fluids, and also as a sheath for protecting and directing optical fibers or CCD cameras for medical or telecommunications applications.

Pipes and hoses of all kinds have been known for a long time that are adapted to transporting liquid or gaseous fluids or indeed powder materials. Such pipes or hoses can be flexible or otherwise depending on the uses to which they are put and on their lengths and diameters, where flexible pipes and hoses are generally of relatively small diameter (up to a maximum of about 20 millimeters) and are designed to be handled and moved manually or mechanically.

With flexible hoses, it is often necessary to make use of devices for supporting or holding said hoses in a determined position, in particular at their ends. Such support or holding devices enable said ends to be held so that they continue to point in a desired direction corresponding either to the axis on which the hose is connected to a tank or to a member for delivering the substance to be transported, or else to the direction in which the substance is to be sprayed or dispensed with the help of suitable means. In the absence of such holding devices, the fluid or the material transported under pressure inside said hose is liable to lead to unwanted movements of the hose whenever one of its ends is not held.

Nevertheless, devices for supporting and/or holding sometimes turn out to be satisfactory in part only. Such devices are generally stationary, which greatly limits the modularity of the positions in which the hose can be used without handling it directly.

Furthermore, said support or holding devices are often not adapted to use in difficult conditions (fire, landslides, hilly country), which means that human intervention is needed for supporting and pointing hoses with all the risks that that involves for the physical safety of the personnel involved.

Each of documents US 2003/184 086, US 2004/074 993, and DE 29 509 507 U1 describes a flexible hose having a central tube in which a fluid can be conveyed, the central tube being covered by a jointed sheath made up of interconnected elements suitable for pivoting relative to one another so as to form a kind of sheath around the central tube. Nevertheless, the hoses described in those documents all present stiffness that is substantially constant and that is determined by the friction force that exists between the interconnected elements forming the sheath of the hose.

Under such circumstances, mere friction between the component elements of the sheath can cease to be sufficient to stiffen the hose correctly and completely against the effects of the internal pressure of the fluid flowing in the central tube so as to hold the hose in a certain position, in particular when the length of the hose exceeds 1 meter and/or its diameter is greater than a few centimeters.

Conversely, such hoses are never completely pliable and flexible because of the constant friction between the elements of the sheath, which reduces the ease with which they can be manipulated.

Document WO 03/103466 A1 also discloses a shower hose suitable for being stiffened by tension from a cable using a mechanical or hydraulic actuator. Nevertheless, such a hose does not comply with the hygiene and safety standards required for goods of that type, and furthermore the stiffener system proposed is not reliable, mechanically.

### OBJECTS AND SPRY OF THE INVENTION

The object of the present invention is to remedy, at least in part, the drawbacks of existing flexible pipes. The invention seeks in particular to provide a pipe having a first state in which it is completely pliable and flexible, and a second state in which it can be stiffened and frozen in a determined position, while continuing to convey a said fluid, material, or other substance of any kind.

Another object of the present invention is to provide a pipe that can be suitable for any type of home or professional use, and in which the flexible or rigid nature thereof is independent of its length and of its diameter.

Another object of the invention is to provide a pipe that can, where appropriate, be guided and moved while in the frozen state by suitable control means.

The invention achieves these various objects by a flexible pipe adapted in particular for transporting fluids or powder materials, the pipe comprising at least one leaktight and flexible tube within which a said fluid or a said material can be conveyed, the pipe comprising a clamping device covering said leaktight tube over at least a fraction of the length of said pipe, preferably over all of the length of said pipe, said clamping device comprising at least one sheath and clamping means for clamping said sheath, said sheath and said clamping means being adapted, at rest, to preserve the pliability and the flexibility of said pipe, and when a determined stress is applied, to stiffen said pipe and freeze its position over the length of said pipe covered by said clamping device.

The pipe of the invention is particularly advantageous in that it can have two different natures, flexible or rigid, depending on the needs of the user and depending on the user acting in simple manner on the clamping device. The pipe of the invention, when rigidly frozen, thus makes it possible to release the hands of the user for performing other tasks while the pipe continues to convey a said fluid or material, for example. Likewise, when the clamping device is at rest, the pipe is as easy to manipulate and move as a traditional flexible hose, thus making it easier to put into place accurately before it is stiffened, and also making it easy to store subsequently.

According to a first advantageous characteristic, the sheath is jointed and said clamping means co-operate with peripheral portions of said sheath at its joints, said clamping means acting, under a said determined stress, to exert pressure forces on said peripheral portions of said sheath, enabling it to be stiffened by locking said joints. Said joints are thus blocked, thereby enabling the pipe to be stiffened.

In a preferred embodiment of the invention, said sheath comprises an assembly of modules each provided with a preferably cylindrical longitudinal bore opening out into opposite ends of said module, in association with complementary link means. Said cylindrical bore formed in each module enables said sheath to be engaged over said leaktight tube of the pipe. Said complementary link means advantageously form said joints of said sheath between two said modules when assembled together, the joints preferably being of the ball joint type.

The ball joints thus enable the modules of the sheath to move angularly relative to one another, thereby conferring flexibility and pliability to said sheath so long as said clamping means are not active.

Also in preferred manner, said clamping means comprise cables of a length not less than the length of said pipe. The cables co-operate advantageously with said peripheral portions of said sheath, in particular said modules thereof, so as to compress said sheath at said joints when a traction force is applied to one end of said cables.

In a first variant embodiment of the pipe of the invention, the sheath of said clamping device is preferably made up of identical modules, each said module being constituted by a circularly symmetrical part comprising firstly a head in the form of a ball having a substantially spherical outer profile, and secondly a flared shell, said shell presenting an inner profile complementary to said outer profile of said head on an identical second module, said head and said shell constituting said complementary link means of each said module.

In a second variant embodiment, said sheath comprises modules of at least two different types, each type of module having a pair of similar link means complementary to the link means of modules of the other type.

In this variant embodiment, said sheath then advantageously comprises male type first modules, each constituted by a circularly symmetrical part having two ball-shaped heads of substantially spherical outer profile, and female type second modules each constituted by a circularly symmetrical part comprising two flared shells of inner profile complementary to said outer profile of said heads of the male type modules, said heads and said shells of said male and female type modules being disposed respectively on the axes of symmetry of said modules and being symmetrical about respective midplanes orthogonal to the said axis of symmetry of each of said modules.

In this second variant embodiment, as in the first, said male and female modules include a said cylindrical bore passing right through along the axis of symmetry of each of said modules, said bore serving to pass said modules over said leaktight tube of the pipe in order to constitute the jointed sheath.

In accordance with another preferred characteristic of the invention, the cables of the clamping device are inserted in guides that are formed in the walls of said shells of said modules, preferably extending parallel to said axis of symmetry of said modules, said cables each having, at a first end, stop means, in particular of the abutment type, for engaging the module closest to said first end, and, at a second end, means for connecting said cables to auxiliary means for applying traction to said pipe.

Advantageously, said clamping means further comprise bands around said cables that are distributed regularly along said sheath of said clamping device, preferably at a rate of one band for every one to fifteen modules of said sheath, more preferably at a rate of one band for every one to six modules. The bands serve in particular to direct the compression forces from the cables towards the shells of the modules when the cables are tensioned by the traction means in order to stiffen the pipe.

In addition, said bands also improve the ability of the pipe to become frozen in a determined position in three dimensions when the cables are tensioned, by, so to speak, subdividing the jointed sheath into sheath “segments”, each comprising a determined number of modules, each said “segment” freezing in the privileged direction in which it was extending when the cables of the clamping device were tensioned.

In order to facilitate and improve the locking of the joints between the modules of the sheath of the pipe of the invention, the walls of the shells of said modules advantageously include slots extending from the rims of said shells to the bases thereof, said slots thus defining flanks in which said guides are formed for the cables of said clamping means.

These slots serve to “weaken” the walls of the shells of the modules so as to make them easier for the cables to compress in order to stiffen the pipe.

To further improve the locking of said joints formed between said modules, the head(s) of a said module preferably includes in its outer surface an annular groove coaxial about said axis of symmetry of the module, said groove receiving means, preferably an O-ring, suitable for increasing adhesion between said head and said shell of two modules that are assembled together.

Advantageously, said clamping device may also include bands surrounding the flanks of said module shells, with the presence of these bands around the flanks thus preventing the flanks deforming and flattening when the pipe is conveying a fluid under high pressure and the tension in the clamping cables is high.

In addition, the pipe of the invention may also include an outer protective sheath covering said clamping device, said protective sheath improving the appearance of the pipe, and also and above all protecting the clamping means and the jointed sheath of said clamping device against corrosion, impacts, and any external attack they might suffer.

In a particular embodiment of the invention, the protective sheath may also replace the cables of the clamping device of the pipe. To do this, it is advantageous for the protective sheath to be made of a material that is elastic and strong. Then, by stretching the protective sheath under a traction force, the diameter of said protective sheath is reduced, thereby stressing the modules of the pipe sufficiently to lock the joints thereof.

As can be seen from the above description, the pipe of the invention presents a structure that is particular, but that is nevertheless very simple to fabricate.

Initially, said modules including said complementary link means are threaded onto a said leaktight and flexible tube, and then said rigid modules are assembled together via their complementary link means so as to build up said jointed sheath around said flexible tube.

Thereafter, said clamping means are positioned to co-operate with said modules of the sheath, and finishing endpieces are secured to the ends of said pipe, said endpieces covering said jointed sheath and said clamping means of said clamping device and communicating with the open ends of said leaktight tube covered by said sheath.

Additionally, when said pipe is to include a protective sheath, said clamping device of the pipe is covered by said protective sheath prior to putting said endpieces into place.

The pipe of the invention finds a particular application in any device adapted to transport substances such as fluids, materials in powder form, or indeed telecommunications cables.

Such devices, which for the most part already exist, do not need any special structural modifications and can merely be fitted with a pipe of the invention as a replacement for an existing pipe, together with at least one actuator for actuating the clamping device of said pipe, such control means being suitable for exerting a said determined stress on the clamping means of the clamping device in order to stiffen said pipe.

For applications in which control over the position and the movements of the pipe are needed, it is also possible to provide for said devices to include at least one individual actuator, in particular a said traction means, for each of said cables of said clamping means of said clamping device of said pipe.

Whatever the application under consideration, a pipe of the invention is simple and quick to use. For example when transporting a fluid, said pipe is initially connected by any suitable means to an actuator and to a source of fluid so that said clamping means of the clamping device and said leaktight and flexible tube of the pipe co-operate and communicate respectively with said actuator and with said source of fluid, after which said flexible pipe is put into a determined position as a function of the particular use being made of the pipe.

Thereafter, said actuator is actuated in order to apply a determined stress to said clamping means, thereby stiffening said pipe and freezing it in said predetermined position in which it was placed, the fluid being transported inside said pipe without being impeded regardless of the position in which said pipe is frozen because the clamping device of said pipe does not in any way pinch or kink the leaktight tube within said pipe.

### BRIEF DESCRIPTION OF THE DRAWINGS

Other characteristics and advantages of the present invention appear in the light of the following description made with reference to FIGS. 1 to 14, in which:

FIG. 1 shows a shower device comprising a pipe of the invention connected at a first end to a shower head and at a second end to control and actuator means for controlling and actuating the pipe clamping device;

FIG. 2 is a fragmentary longitudinal section view showing the pipe of the invention connected to the control and actuator means of FIG. 1;

FIGS. 3A to 3C are respectively a face view, a plan view, and a longitudinal section view on plane C-C showing a component module of the jointed sheath of the pipe of the invention in a preferred embodiment;

FIGS. 4A and 4B are respectively a section view and an overall view of the structure of the pipe clamping device of the invention;

FIG. 5 shows a shower device comprising a variable-stiffness pipe connected at a first end to a shower head and at a second end to actuator of another type, itself connected to a water faucet;

FIG. 6 is a view of the FIG. 5 actuator and the assembly of parts constituting it, shown exploded along its longitudinal axis XX′;

FIG. 7 shows the actuator of FIGS. 5 and 6 in longitudinal section on its axis ZZ′ when in a rest position;

FIG. 8 is a perspective view and a fragmentary section view showing the positioning means of the actuator of the invention;

FIG. 9 is a section view on plane IX-IX of FIG. 7;

FIG. 10 shows the actuator of FIGS. 5 and 6 in longitudinal section on its axis ZZ′ in an actuation position;

FIGS. 11A and 11B are respective perspective views showing the relative displacement of the positioning means of the actuator of FIGS. 5 and 6 on being displaced from the rest position towards the actuation position, and vice versa;

FIG. 12 shows the actuator of the invention in longitudinal section view on its axis ZZ′, showing the thrust means of the actuator moving from their actuation position towards their rest position; and

FIGS. 13 and 14 show the connection between the actuator and a variable-stiffness pipe, and they show the co-operation between the thrust means of the actuator and the device for clamping said pipe when said thrust means are in the rest position and in the actuation position, respectively.

### MORE DETAILED DESCRIPTION

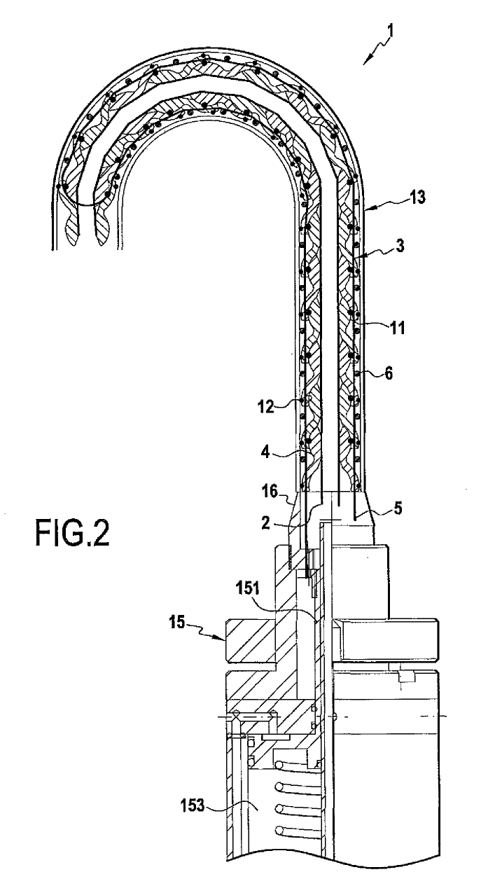

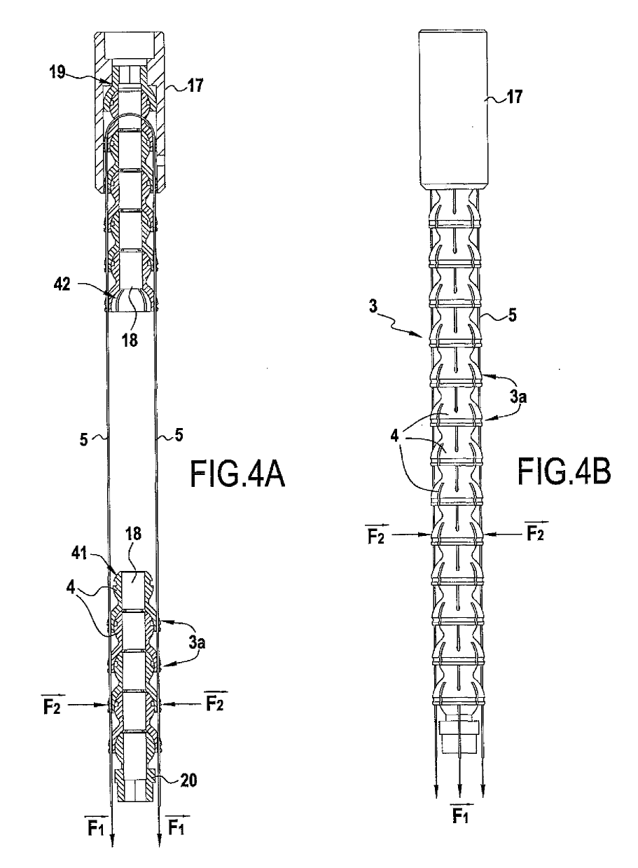

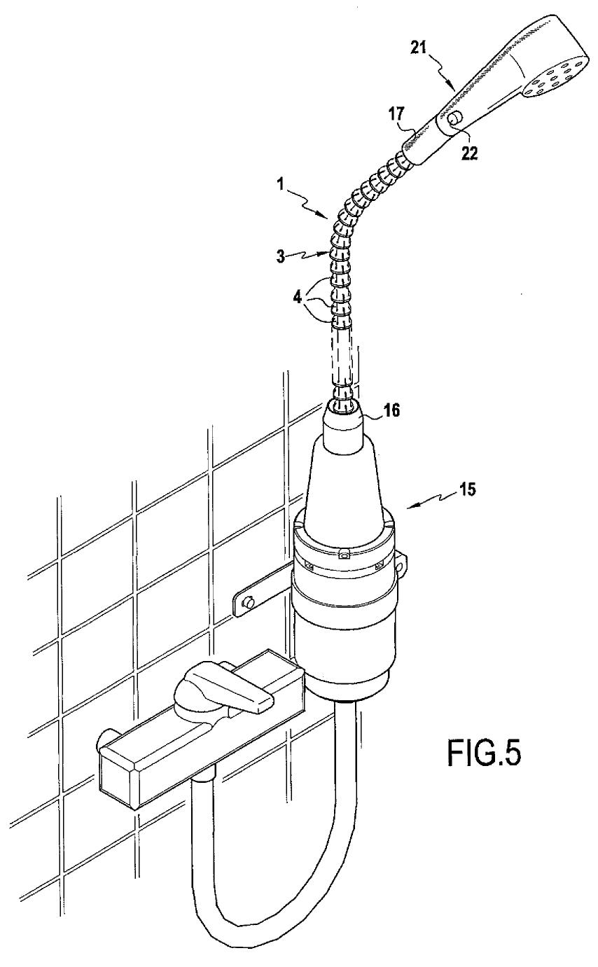

The pipe of the invention presents a singular structure from which there stem particular properties of flexibility and pliability, or on the contrary of stiffness, these properties depending on the state of various elements constituting said pipe. With reference initially to FIGS. 2 and 4A, 4B, the pipe 1 of the invention comprises a flexible leaktight central tube 2, said tube being adapted in particular for transporting fluids and/or material in powder form.

The central tube 2 is covered in a clamping device comprising firstly a jointed sheath 3 made up of modules 4 assembled to one another by complementary link means 41, 42, said jointed sheath 3 having an internal cylindrical channel 18 through which said tube 2 can pass.

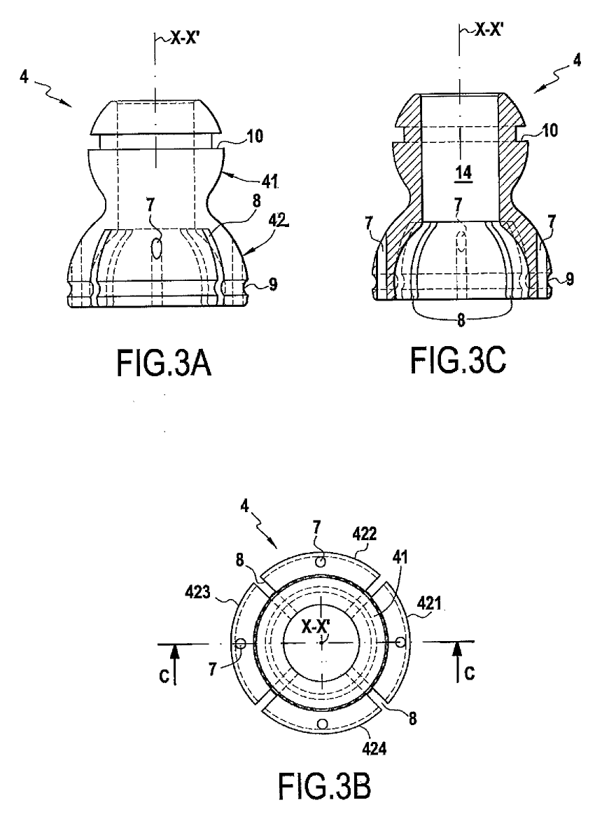

In the embodiment described, the jointed sheath 3 is made up of a plurality of identical modules 4 as shown in detail in FIGS. 3A to 3C, together with two end modules 19 and 20. These modules 4, 19, 20 are assembled to one another by the complementary link means 41, 42 forming a ball-and-socket type joint 3a between each module 4 of the sheath 3, the joint 3a allowing each module of the sheath to flex through an angle of about 40°, thereby imparting pliability and flexibility to the sheath.

Each module 4 is constituted by a cylindrical body of revolution made of metal, or preferably of a strong plastics material such as high density polyethylene (HDPE), polypropylene (PP), or indeed acetal. Nevertheless, other materials could also be used for making the modules 4, selected as a function of the cost acceptable for the pipe 1 and also the mechanical stresses it is required to withstand while in use.

A said module 4 can be obtained by casting or injection-molding, and machining, for example. It comprises a ball-shaped head 41 having a flared hollow shell 42 extending from its base, said head and said shell constituting said complementary link means of the modules 4. For this purpose, the spherical outer profile of the head 41 is complementary in shape to the substantially hemispherical inner profile of the recess in the shell 42. Furthermore, in order to enable the head 41 of a first module to be snap-fastened easily and effectively in the shell 42 of a second module, the diameter of the recess in the shell at its rim is very slightly smaller than its maximum inside diameter which corresponds to the maximum outside diameter of said head 41.

In order to form said internal cylindrical channel 18 of the sheath 3, the top spherical cap of each module 4 is omitted and said module is pierced along its axis of symmetry XX′ by a central cylindrical bore 14 opening out on either side of the head 41 through said cap of the module and inside the recess of the shell 42, said bore having a diameter that is slightly greater than the outside diameter of the leaktight tube 2.

The end modules 19 and 20 are likewise pierced by a cylindrical bore, but they comprise respectively only a shell 42 and only a head 41, the remaining portions of their bodies forming couplings enabling endpieces 16, 17 to be put into place at the ends of the sheath 3 of the pipe 1.

The wall of the shell 42 of a module 4 includes slots 8 subdividing the wall into flanks 421, 422, 423, 424, and also guides 7 pierced parallel to said axis XX′ of the module in the thickness of each flank. The slots 8 and the guides 7 are four in number, being regularly distributed at 90° intervals around the axis XX′, and they serve respectively to increase the flexibility of the walls of the shell 42 by forming said independent flanks, and for passing cables 5 for clamping the sheath 3. Said cables co-operate with said flanks 421, 422, 423, 424 at said joints 3a. Thus, when the cables 5 are put under tension with a force F1, the cables exert compression forces F2 on said flanks, thereby locking the joints 3a between the modules 4 so as to freeze the pipe.

In a variant embodiment of the invention that is not shown in the figures, the modules making up the jointed piece 3 may be of two different types, and in particular modules of a male, first type, each having two heads similar to the head 41 of the modules 4, and modules of a female, second type, each having two shells similar to the shell 42 of the modules 4, the shells being disposed back to back, with the jointed sheath thus being made up of alternating male type modules and female type modules.

The cables 5 which be made of metal, e.g. of stainless steel, or of a plastics material such as Nylon®, are of a length that is not less than the length of the pipe 1, and there may be four individual cables or else two cables looped along the length of the sheath 3 as shown in FIGS. 2 and 4A, and they include at least one of their ends connection means (not shown) for connecting to a traction member. Said connection means can easily be integrated, e.g. in an endpiece such as the endpiece 16 of FIG. 2, thereby avoiding excessive freedom for the ends of said cables 5 and avoiding excessive wear thereof.

With reference to FIG. 2, rings or bands 6 are placed around the cables 5 between the joints 3a. These bands 6 serve to direct the compression forces from the cables 5 under tension towards the flanks of the shells 42, thereby increasing the clamping of the cables against the modules 4 and the pinching of the shells 42 against the head 41 so as to block the joints 3a and freeze the pipe in a determined position. The number of these bands 6 may vary as a function of the stiffness it is desired to obtain in the end for the pipe, and also on its length. In general, it is appropriate to position one band 6 for every one to fifteen modules, and preferably for every one to six modules in order to obtain satisfactory stiffness for the pipe, even when it has numerous large bends.

The jointed sheath 3 made up of the modules 4, the cables 5, and the bands 6, thus forms the clamping device of the pipe 1 of the invention that enables said pipe to be flexible when the cables 5 are at rest and to be stiffened when the cables 5 are tensioned by a control and actuator device (traction member), which is selected as a function of the utilization intended for the pipe 1 and also as a function of its length and its diameter. An appropriate said traction member could be constituted, in particular, by an electrical, pneumatic, or hydraulic type of actuator, or it could be of the winder type.

In a particular embodiment of the pipe of the invention, the modules 4 may also include respective O-rings 11 around their heads 41 so as to increase adhesion between each head and the inside of the flanks of the corresponding shell 42, thereby further improving the locking of the joints 3a of the sheath 3 when the cables 5 are tensioned. For this purpose, said heads 41 of the modules 4 can include respective annular grooves 10 disposed concentrically around the cylindrical bore 14 of each said module, each groove receiving a said O-ring 11, where appropriate.

Additionally, the flanks 421, 422, 423, 424 of the shell 42 of a module 4 of the jointed sheath 3 may also be surrounded by a ring or band 12 received in a groove 9 formed close to the ring of the shell 42. The ring 12, which is optional for the function of stiffening the pipe 1, is nevertheless useful for preventing the shells becoming flattened and deformed when the pressure from the cables is large.

In order to improve the overall appearance and also and above all in order to protect the elements of the clamping device thereof, the pipe 1 of the invention also includes a protective sheath 13 covering the jointed sheath 3, the cables 5, the bands 6, and preferably also the endpieces 16 and 17 at the ends of said pipe. In an embodiment that is not shown, when the material of the protective sheath 13 is selected to be sufficiently strong and elastic, serve to replace the clamping cables 5 so as to apply the stress to the modules 4 for locking the joints 3a of the pipe.

The pipe 1 of the invention is particularly advantageous because of its ability to be pliable and flexible, or conversely rigid and frozen in a position that is determined by the user, as a result of the user applying a control action depending on the use to be made of the pipe. This flexible or rigid characteristic of said pipe is determined exclusively by the state of the clamping device, which does not apply stress at any time to the central tube 2, even when the cables 5 are compressing the flanks 421, 422, 423, 424 of the shells 42 of the modules so as to freeze the pipe, thus ensuring that the flow transported in said tube 2 is never impeded.

The pipe 1 is thus suitable for a large number of diverse and varied applications for home and professional use, providing comfort in use that is most important for users.

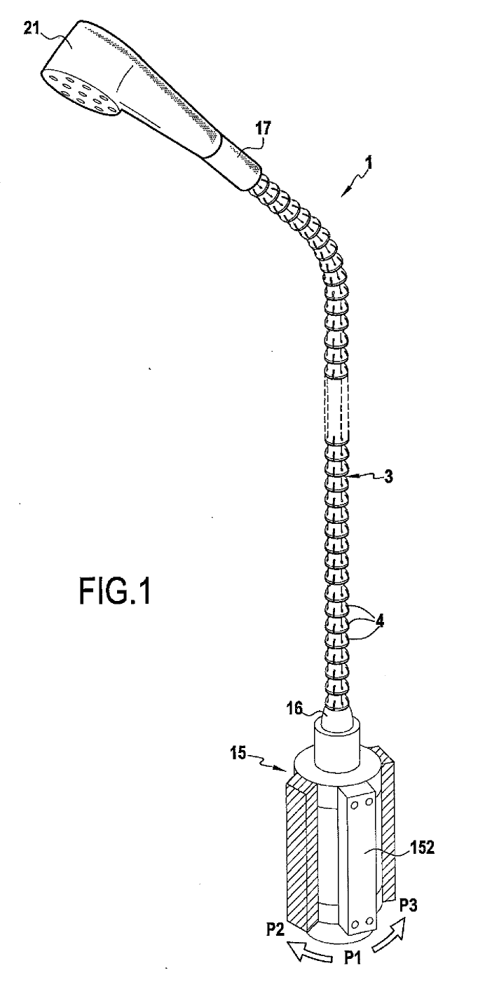

As shown in FIGS. 1 and 2, the pipe 1 is particularly adapted to being used as a shower hose in association with a suitable actuator 15, e.g. suitable for exerting traction on the cables 5 of the pipe 1, as shown in FIGS. 1 and 2. Initially, said pipe 1 is connected via its endpiece 16 to a hydraulic actuator 15 itself connected to a water outlet (not shown). Connecting the pipe 1 to the actuator 15 includes linking the cables 5 of the clamping device of the pipe to the rod 151 of the actuator 15, and connecting the central tube 2 to the water outlet for the shower. At the other end of the pipe, the endpiece 17 enables a traditional shower head 21 to be put into place by screw-fastening or snap-fastening.

The hydraulic actuator 15 includes a control handle 152 enabling the clamping device of the pipe to be actuated or not actuated. Thus, in a first position P1 of the control handle, the actuator 15 serves solely to pass water to the inside of the tube 2 in the pipe 1 like a traditional faucet, said pipe then being flexible and pliable, the cables 5 of its clamping device not being tensioned. If the user subsequently desires to have the hands free for applying soap or washing hair, for example, then the user puts said flexible pipe 1 in the position it is to keep, and then turns the handle 152 towards the second position P2 in which the clamping device of the pipe 1 is actuated.

Turning the handle 152 stops water from flowing along the tube 2 of the pipe 1 towards the shower head 21 and diverts the water to a circuit for filling the chamber 153 of the actuator. Filling said chamber causes the actuator rod 151 to move, thereby applying traction to the cables 5. The cables 5 as centered in this way apply transverse compression forces against the shells 42 under guidance from the bands 6, thereby clamping the flanks 421, 422, 423, 424 of said shells against the heads 41 of the modules 4 of the jointed sheath 3, and thus locking the joints 3a of said sheath, said locking of the joints 3a causing the pipe 1 to be frozen and stiffened over its entire length in the position selected by the user.

Once said pipe is stiff, the user returns the handle 152 of the actuator 15 towards its first position so that water flows again inside the tube 2 towards the shower head so that the user can shower in the manner usual with a fixed shower head. Nevertheless, if the user desires to make the pipe 1 flexible again, it suffices to turn the control handle 152 towards a third position P3 causing the chamber 153 of the actuator to be empty and the rod 151 thereof to rise and relax the cables 5, thereby releasing the joints 3a of the sheath 3 in the pipe so as to allow the modules 4 of said sheath to move angularly again, thus making the pipe flexible.

In a variant, it is also possible to replace the above-described actuator 15 with an analogous device in which the actuator, instead of pulling the cables 5, pushes the modules 4 under the pressure of the water or fluid diverted for this purpose, with the cables 5 then remaining stationary and only the modules 4 being displaced and becoming compressed so as to stiffen the pipe 1. One such actuator is shown in detail in FIGS. 5 to 14.

The pipe 1 is then connected at its second end to the actuator 15 via a connection member 16. This connection member may be of the screw-coupling or snap-fastening type, and is fastened to the end of the pipe 1 and screw-fastened or snap-fastened to the actuator 15 which includes complementary connection means.

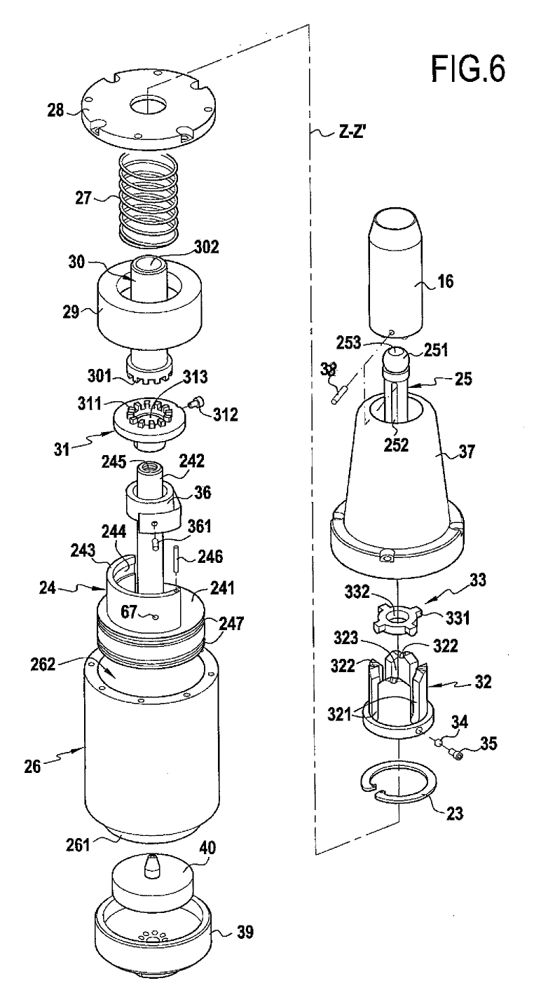

Going from its base to its top, the actuator 15 comprises a hollow cylindrical bottom 39 pierced in its middle by a water injection orifice communicating with the opening in a connection endpiece formed under the bottom 39 (FIG. 6).

A cylindrical jacket 26 is engaged or screwed on top of said bottom 39 via a tubular endpiece 261 secured to an end wall 263 of said jacket 26. In the base provided between the bottom 39 and the end wall 263 there is housed a nozzle 40 with its spout passing through the end wall 263 via an orifice pierced in its center.

The inside of the jacket 26 forms a compression chamber 262 receiving a piston 24. The piston comprises a disk 241 from which there extends a thrust shaft 242. O-rings 247 provide sealing between the cylindrical surface of the disk 241 and the walls of said chamber 262.

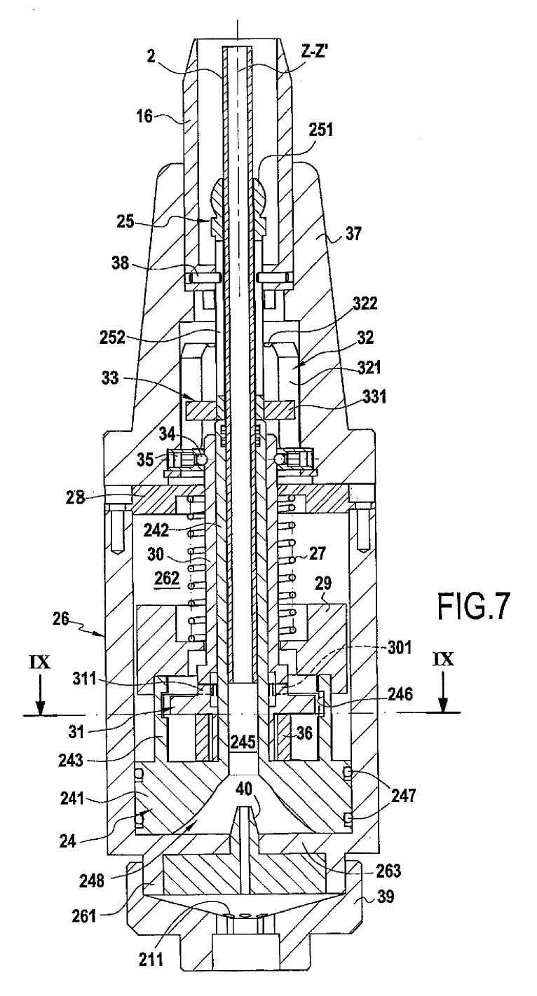

As can be seen more clearly in FIG. 7, the piston 24 also has a bore 245 pierced axially in the shaft 242 and in the disk 241 of the piston, said bore 245 forming a flow duct that opens out to both ends of the piston and that is terminated by a substantially conical hollow 248 formed in the body of the disk 241 from its bottom surface.

From the top surface of the disk 241, there also extends a semicylindrical wall 243 about the axis and spaced apart from the shaft 242 of the piston, and including in its inside face a groove 244. This wall 243 constitutes means for guiding and locking the rotation of a ring 31 mounted to rotate freely with its central bore 313 disposed around the shaft 242 of the piston.

The ring 31 overlaps a spring blade 36 likewise mounted on the shaft 242 of the piston and having its outer end connected to the wall 243 of said piston by a pin 361 inserted in an orifice of said wall 243 and having its inner end held in a groove formed in the ring 31.

The stroke of the ring 31 around the shaft 242 of the piston, and thus the stress in the spring 36, is limited by a first abutment 312 projecting radially from the ring 31 and engaged like a slider in the groove 244 in the wall 243 of the piston, a rod 242 being inserted vertically in the thickness of said wall 243 so as to form in said groove 244 a second abutment against which the abutment 312 of the ring 31 becomes blocked, thereby allowing a maximum angle of rotation of about 360° for the ring about the shaft 242 of the piston (FIG. 9).

Above the ring 31, and in contact therewith, there is a tubular bushing 30 likewise mounted free to rotate about the shaft 242 of the piston 24 by means of a central bore 302. In its base, said bushing 30 has a downwardly-directed crown 301 complementary to a notched surface 311 formed on the ring 31, said crown 301 and said notched surface 311 serving to couple the ring 31 with the bushing 30 by meshing.

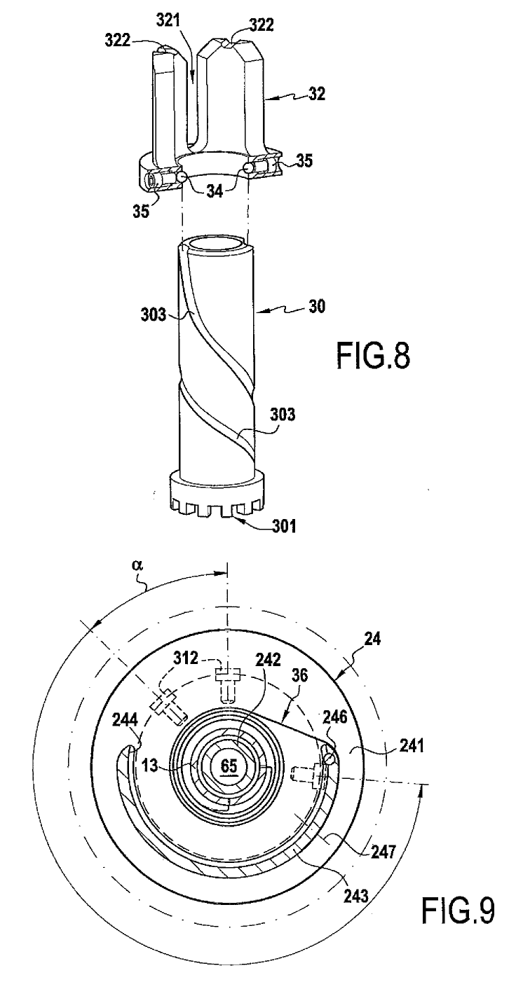

As shown in FIG. 8, the bushing 30 also has two identical helical threads 303 in its outside surface. These threads 303 co-operate with male elements 34 described to guide the bushing 30 that meshes with the ring 31 in rotation, thereby applying tension to the spring blade 36 when the piston 24 is raised in the compression chamber 262.

A ring-shaped clamp 29 is also engaged around the shaft 242 of the piston, around the bushing 30, and bearing against the top rim of the wall 243 on the piston.

The compression chamber 262 is closed by a removable end plate 28 having a central circular opening of diameter equal to the diameter of the shaft 242 of the piston covered by the bushing 30 which thus extends outside the compression chamber 262 through said opening, a compression spring 27 coaxial with the shaft 242 of the piston and with the bushing 30 being interposed between said end plate 28 and the clamp 29 so as to cause said clamp 29 to be pressed against the piston 24 so as to hold it at the bottom of the compression chamber.

A cover 37 is releasably secured by screw-fastening onto the jacket 26 of the actuator. The cover 37 has two internal housings, a bottom housing covering a tubular barrel 32, a cross 33, and a thrust member 25, all coaxial about the axis ZZ′ and each having a central bore 323, 332, 253, and an upper housing for connection to a coupling endpiece 16 of the variable-stiffness pipe, said endpiece 16 covering the end 251 of the thrust member 25.

The barrel 32 has its central bore 323 mounted on the end of the shaft 242 of the piston 24 covered by the bushing 30 that leaves the compression chamber 262 via the central orifice in the end plate 28 on the jacket 26. In co-operation with the bushing 30 and also with the cross 33, said barrel 32 constitutes means for positioning and locking the thrust member 25, having its bottom end resting on the top end of the shaft 242 of the piston 24 between the walls of the barrel 32. The barrel has two series of notches 321, 322 machined longitudinally in said walls, the notches 321 being of depth substantially equal to the height of the barrel 32 and the notches 322 being very shallow, having a depth of a few millimeters, in the top rims of the walls of the barrel, each notch 321 being offset by an angle of 45° from a notch 322 and by an angle of 90° from another notch 321, thereby creating a regular alternation of notches 321 and 322 around the entire circumference of the barrel 32, thus giving it the shape of an upwardly-directed crown.

Furthermore, as shown in greater detail in FIG. 8, said barrel 32 also includes balls 34 at its base for coupling said barrel with the bushing 30 on the shaft 242 of the piston 24, said balls 34 being diametrically opposite on the inside face of the central bore 323 of the barrel so as to engage in the threads 303 formed in the bushing 30, adjustment screws 35 being used during assembly to adjust the depth to which the balls penetrate into said threads 303.

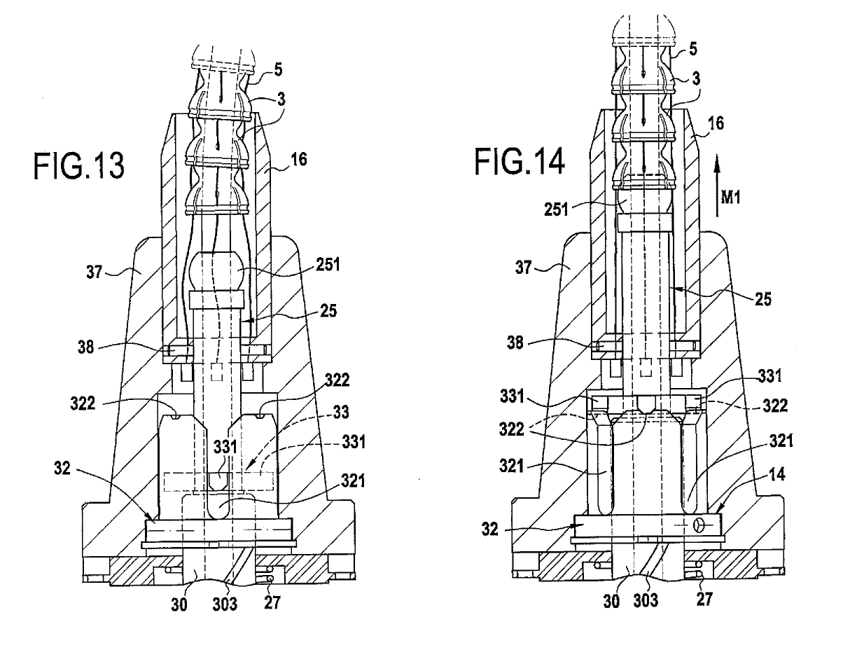

The thrust member 25 takes the form of a finger having a top end 251 that is complementary in shape to the bottom end of the sheath of the variable-stiffness pipe 1 that is connected to the actuator by its clamping cables 5 secured to the base of the coupling 16, said coupling itself being inserted in the cover 37, as shown in FIGS. 13 and 14. At its bottom end, said thrust member is secured to the cross 33 whose arms 331 are inserted in the notches 321 of the barrel 32 when the actuator is at rest. In addition, guide grooves 252 can also be formed along two generator lines of said thrust member 25 from the cross 33 as far as the head 251 thereof, pins 38 extended transversely to the base of the coupling 16 penetrating into said grooves 252 so as to prevent said thrust member from turning during its movements along the axis ZZ′ under drive from the piston 24.

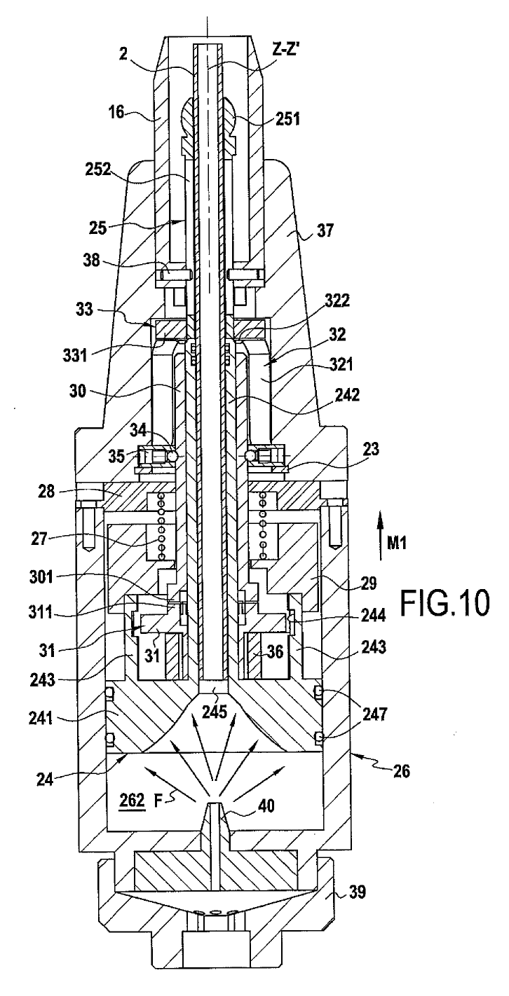

The piston 24 and the thrust member 25 constitute thrust means movable along the longitudinal axis ZZ′ between a rest position (FIG. 7) and an actuation position (FIG. 10), and their respective bores 245, 253 communicate, thus enabling said leaktight and flexible water flow tube 2 to be inserted in the pipe 1, as shown in FIGS. 7, 10, and 12, in particular.

In addition, the ring 31, the spring blade 36, the bushing 30 the barrel 32, the cross 33, and the balls 34 constitute positioning and locking means that co-operate with said thrust means 24, 25 to apply a force against the sheath 3 and the cables 5 of the variable stiffness pipe 1, or to release said force.

With reference to FIGS. 5, 7, and 13, and as mentioned above the actuator 15 is controlled from the shower head 21 by means of a button 22 for controlling the delivery of water to the shower head. In the normal state, the variable-stiffness pipe 1 is flexible like a traditional shower hose.

When the faucet is opened, water begins by penetrating into the actuator 15 via the orifices 211 in the bottom 39 and then into said tube 2 and into the pipe 1 as far as the shower head 21. The piston 24 is then in its low, or rest position inside the compression chamber 262, with the force from the compression spring 27 being greater than the pressure of the water at the base of the piston. Simultaneously, the thrust member 25 is in contact with the end of the shaft 242 of the piston and the arms 331 of the cross 33 in the notches 321 of the barrel 32, its thrust head 251 not bearing against the top module of the sheath 3 of the pipe 1, so that the cables 5 therein are slack (FIG. 13). The user can then use the shower like a traditional shower.

If the user subsequently desires to have both hands free for soaping or washing the hair, for example, the user places the pipe 1 in the position in which it is to become stiff, and then presses against the button 22 for preventing water from reaching the shower head 21. Water can then no longer flow through the shower head. As a result water coming from the faucet becomes compressed in the camber 262 of the actuator, at the base of the piston 24, thus causing the piston 24 to be raised, as shown in FIGS. 6, 10, and 14, and consequently causing the thrust member 25 to move in the direction of arrow M1 under the pressure of the water against the disk 241 so as to go from the rest position (FIGS. 7 and 13) to said actuation position (FIGS. 10 and 14).

The movement of the piston 24 in translation under pressure from the water leads to simultaneous turning of the ring 31 and the bushing 30, which are coupled together via their notched contacting portions 301, 311, through an angle α (FIG. 9) of about 40° to 50°, and more particularly lying in the range 42° to 47°, about the shaft 242 of the piston. This turning of the ring 31 and of the bushing 30 leads to the blade spring 36 being compressed, and is itself driven by the balls 34 of the barrel 32 being moved along the threads 303 of the bushing, said barrel itself being prevented from turning by the arms 331 of the cross 33 at the base of the thrust member 25 and received in its notches 321.

When said piston 24 and said thrust member 25 have reached their said actuation position (FIG. 10), the head 251 of the thrust member 25 exerts thrust on said sheath 3, causing said sheath 3 to be compressed and tensioning the cables 5 which then apply transverse forces to the joints formed between the modules of the sheath 3, which joints are then blocked so the pipe 1 is stiffened. Simultaneously, the arms 331 of the cross 33 at the base of said thrust member 25 are extracted from the notches 321 of the barrel 32, so the barrel is thus released to turn, as is the spring blade 36 that connects the ring 31 coupled to the bushing 30 with the shaft 242 of the piston.

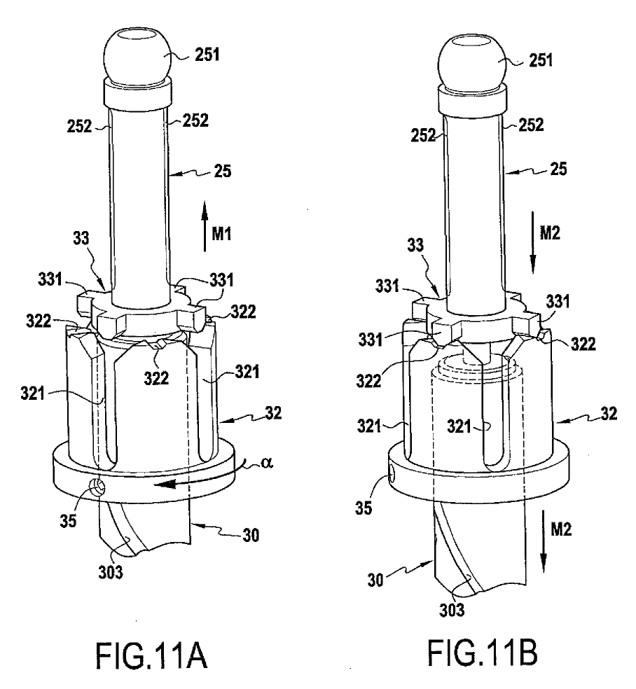

As shown in FIG. 11A, releasing said spring blade 36 then causes said ring 31 of said bushing 30 to turn through an angle α in the opposite direction to that adopted by said bushing and said ring while the piston 24 is rising into the actuation position, said bushing entraining the barrel 32 so that it pivots through said angle α of value that is determined by the pitch of the thread 303 in the bushing and as a function of the length of the shaft 242 of the piston, in a manner known to the person skilled in the art. This turning of the barrel 32 which takes place as soon as the arms 331 of the cross 33 escape from the notches 321 of said barrel, causes the shallow notches 332 to take up positions in register with said arms 331 of the cross 33.

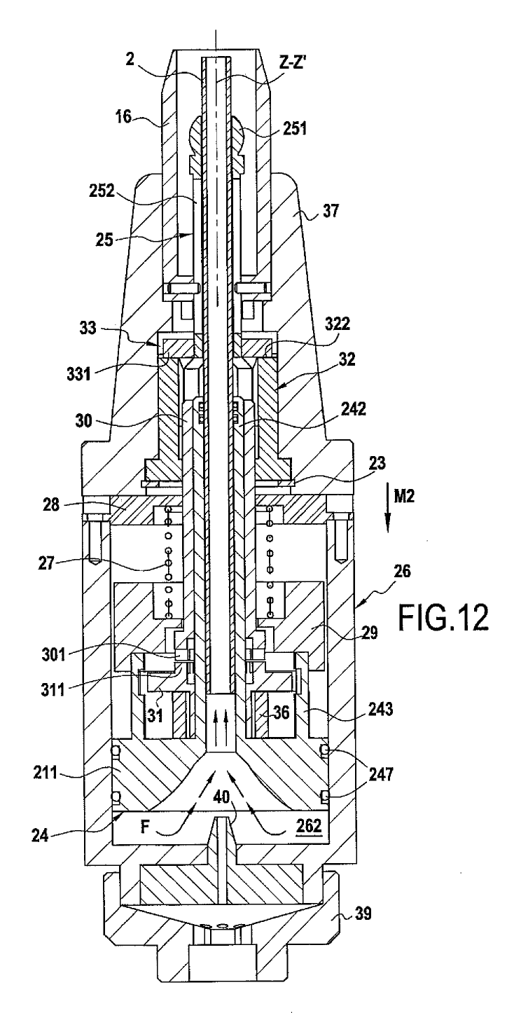

The return M2 of the piston 24 to its rest position then makes it possible, as shown in FIGS. 11B and 12, for the thrust member 25 to be lowered a little and for the arms 331 of the cross to become positioned in the notches 322 of the barrel 32, thereby holding said thrust member 25 in the high, actuation position, while the piston 24 returns to the rest position.

This return M2 of the piston takes place as a result of the user pressing again on the button 22 of the shower head 21. Water then flows again from the faucet to the shower head 21 inside the tube 2, passing through the bores 253 and 245 of the thrust member 25 and of the piston 24 respectively, thereby reducing the pressure of water in the chamber 262 and enabling the piston 24 to return along arrow M2 to its rest position under drive from the compression spring 27 that was compressed by the piston rising, while the thrust member 25 remains blocked in the high position by the cross 33 and the barrel 32.

While the piston is moving down M2, it is appropriate for the ring 31 and the bushing 30 to be decoupled so as to avoid stressing the spring blade 36 in a direction opposite to the direction in which it is wound. This uncoupling is made possible firstly by the existence of clearance h of a few millimeters between the clamp 29 and the downwardly-directed crown 301 at the base of the bushing 30, and secondly by the friction between the balls 34 of the barrel 32 in the threads 303 of the bushing 30, which friction causes the bushing 30 to be retained while the piston 24 begins its descent M2 under thrust from the clamp 29 against the wall 243, where said retention is sufficient to cause the notched portions 301, 311 of the bushing and of the ring 31 to separate, insofar as said ring is itself constrained to move with the piston 24 by the spring 36.

In order to improve emptying of the compression chamber 262 and the descent M2 of the piston, the disk 241 of the piston 24 has a hollow 248 in its bottom surface that is of conical shape, enabling a suction effect to be created that urges water towards the inside 245 of the shaft 242 of the piston 24 as it moves back downwards, the flow of water injected by the nozzle 40 towards the shaft 242 also encouraging this suction effect.

If the user then desires to return the variable-stiffness pipe 1 to its flexible condition, it suffices to press again on the button 22 of the shower head 21 so as to cause the compression chamber 262 to become filled again, thereby causing the piston 24 to rise M1 again towards the actuation position (in which the thrust member 25 is still blocked). As before, the rise of the piston causes the bushing 30 to couple with the ring 31, and then causes these two elements to turn, while simultaneously compressing the spring blade 36 because of the balls 34 of the barrel 32 sliding in the threads 303 of the bushing.

When said piston reaches said actuation position, the top end of its shaft 242 raises the thrust member 25 and the cross 33, thereby separating the arms 331 from the notches 322 in the barrel so that the barrel then turns again through an angle α of 45° so that the notches 321 are again in alignment with the arms 331 of the cross 33. New pressure by the user on the button 22 of the shower head leads to the compression chamber 262 being emptied and to the piston 24 descending M2, the return of the thrust member 25 to the rest position (FIGS. 7 and 13) this time being permitted by the arms 331 sliding in the deeper notches 321 of the barrel 32. Once in the rest position, the piston 24 and the thrust member no longer exert any pressure on the sheath 3 or the cables 5 of the variable-stiffness pipe 1, which consequently returns to being pliable and malleable.

As can readily be understood from the above description, the pipe 1 of the invention, when used as a shower hose, makes it possible for example in medical circumstances for nurses and assistants to shower a patient while having both hands free. Handicapped people also find great comfort in using the pipe of the invention for showering.

The pipe of the invention is also particularly well suited for watering gardens, or indeed fire-fighting where it enables fire-fighters to freeze a fire-hose in a determined direction without having to hold it and remain close to the flames, with all the risks that that implies.

The pipe of the invention can equally well convey any substance that is gaseous, liquid, or organic, or indeed optical fibers or electric cables, thus covering a wide range of utilizations in fields such as domestic applications, industry, the food industry, or defense systems. For applications to guiding optical fibers or to endoscopy, for example, it is also possible for example to provide for each of the cables 5 of the clamping device of the pipe 1 to be manipulated individually by means of appropriate control and actuator devices, thus enabling the position of the pipe to be varied while it is rigid, by acting on the individual tensions of each of the cables.

The present invention is described above with reference to the accompanying figures in a particular embodiment and application that are not limiting in any way on the scope of the invention. Numerous variations in dimensions, shapes, and materials of the component elements of the pipe can readily be envisaged by the person skilled in the art as a function of particular applications for said pipe, without thereby going beyond the ambit of the present invention.

What is claimed is:

1. A flexible pipe adapted in particular for transporting fluids or powder materials, the pipe comprising at least one leaktight and flexible tube within which a said fluid or a said material can be conveyed, the pipe comprising a clamping device covering said leaktight tube over at least a fraction of the length of said pipe, preferably over all of said pipe, said clamping device comprising at least one sheath and clamping means for clamping said sheath, said sheath and said clamping means being adapted, at rest, to preserve the pliability and the flexibility of said pipe, and when a determined stress is applied, to stiffen said pipe and freeze its position over the length of said pipe covered by said clamping device.

2. A pipe according to claim 1, in which said sheath is jointed and said clamping means co-operate with peripheral portions of said sheath at its joints, said clamping means acting, under a said determined stress, to exert pressure forces on said peripheral portions of said sheath, enabling it to be stiffened by locking said joints.

3. A pipe according to claim 2, in which said sheath comprises an assembly of modules, each provided with a preferably cylindrical longitudinal bore opening out in opposite ends of said module, and with complementary link means, said cylindrical bore enabling said sheath to be threaded over said leaktight tube of said pipe, and said complementary link means forming said joints of said sheath when said modules are assembled together.

4. A pipe according to claim 2, in which said clamping means comprise cables of length not less than the length of said pipe, said cables co-operating with said peripheral portions of said sheath, in particular said modules thereof, so as to compress said sheath at said joints under a traction force applied to one end of said cables.

5. A pipe according to claim 3, in which said complementary link means of said modules of said sheath form a ball type joint between two of said modules when assembled together.

6. A pipe according to claim 3, in which said modules of the sheath of said clamping device are identical, each module being constituted by a circularly symmetrical part having a head in the form of a ball of substantially spherical outer profile, and a flared shell, said shell presenting an inner profile complementary to said outer profile of said head of an identical second module, said head and said shell constituting said complementary link means of each said module.

7. A pipe according to claim 3, in which said sheath comprises at least two different types of module, such that:
each module type has a pair of similar link means complementary to link means of modules of the other type;
male type first modules being constituted by a circularly symmetrical part having two heads in the form of balls of substantially spherical outer profile; and
female type second modules constituted by circularly symmetrical parts each comprising two flared shells of inner profile complementary to said outer profile of said heads of the male type modules;
said heads and said shells of said male and female type modules respectively being disposed on the axis of symmetry of said modules and being symmetrical about respective midplanes of said modules orthogonal to said axis of symmetry.

8. A pipe according to claim 6, in which cables are inserted in guides formed preferably parallel to said axis of symmetry of said modules in the walls of said shells of said modules, said cables having stop means at first ends thereof, in particular stop means of the abutment type, for engaging the module closest to said first end, and, at second ends, means for connecting said cables to traction means auxiliary to said pipe.

9. A pipe according to claim 4, in which said clamping means further comprise bands around said cables and distributed regularly along said sheath of said clamping device, preferably at a rate of one band every one to fifteen modules of said sheath, more preferably at a rate of one band every one to six modules.

10. A pipe according to claim $, in which the walls of said shells of said modules include slots extending from the rims of said shells to the bases thereof, said notches thus defining flanks in which said guides are formed for guiding the cables of said clamping means.

11. A pipe according to claim 6, in which the or each head of a said module includes in its outer surface an annular groove coaxial with said axis of symmetry of the module, said groove receiving means, preferably an O-ring, suitable for increasing adhesion between said head and a said shell once modules are assembled together.

12. A pipe according to claim 10, in which said clamping device also includes bands surrounding said flanks of said shells of the modules of said jointed sheath.

13. An actuator for a variable-stiffness flexible pipe according to claim 1, the actuator comprising:
connector means for connecting said actuator to a source of a said fluid;
connector means for connection to one end of said flexible pipe; and
an actuator device for actuating the clamping device of said pipe, the actuator device comprising:
thrust means adapted both to communicate with said leaktight and flexible tube of said pipe and with said fluid source, and also to co-operate with said sheath of the clamping device of the pipe and with said fluid, and
positioning means for positioning said thrust means;
said thrust means and said positioning means co-operating to respond to an action of the fluid on said thrust means triggered by a user closing said leaktight and flexible tube of said pipe to apply or release a stress on the clamping device of said pipe connected to said actuator in order to stiffen or soften said pipe, respectively.

14. An actuator according to claim 13, wherein said thrust means are movable along a longitudinal axis ZZ′ of said actuator between a rest position and an actuation position, and include a piston mounted to move inside a compression chamber communicating with said source of fluid, and a thrust member presenting an end of shape complementary to the shape of the end of said sheath of the clamping device of the pipe for connecting to said actuator.

15. An actuator according to claim 14, wherein said piston includes a disk in contact with the walls of said compression chamber and a thrust shaft extending along said longitudinal axis ZZ′ of the actuator from said disk to the outside of said chamber and co-operating with said thrust member.

16. An actuator according to claim 13, wherein said positioning means include locking means for locking said thrust means, and guide means for guiding said locking means in rotation.

17. An actuator according to claim 14, including at least one resilient return means for returning said thrust means to the rest position, preferably of the compression spring type, placed inside the compression chamber, and at least one resilient return means for returning said positioning means in rotation, preferably of the spring blade type, secured to said piston and to at least one of said positioning means.

18. An actuator according to claim 15, wherein said rotary guide means comprise a cylindrical ring and bushing mounted free to rotate on the thrust shaft of said piston, said ring and said bushing including meshing means enabling said ring and said bushing to be coupled together during displacement of said piston from said rest position to said actuation position, and enabling them to be uncoupled during displacement from said actuation position to said rest position.

19. An actuator according to claim 15, wherein said locking means comprise a barrel mounted to rotate freely about the shaft of the piston, and about the thrust member, said barrel having at least two series of notches of different depth forming alternating indentations in the walls of said barrel around the entire circumference thereof, said indentations being adapted to co-operate with locking elements of complementary shape secured to said thrust member, said locking elements being placed in said notches during the displacements of said thrust means.

20. An actuator according to claim 19, wherein said bushing of the rotary guide means includes at least one outer thread co-operating with at least one male element, preferably a ball or a stud, placed in the inner bore of said barrel so as to entrain said bushing and said ring in rotation during movements of the thrust means from their rest position towards their actuation position.

21. An actuator according to claim 19, wherein said rotary resilient return means are secured to said ring of said rotary guide means so as to cause said barrel to turn when said locking elements escape from the notches of said barrel, said thrust means then being in the actuation position.

22. An actuator according to claim 19, wherein the thread in the bushing is such as to cause said barrel to turn through an angle lying in the range 40° to 50°, preferably in the range 42° to 47°, as a result of said rotary resilient return means being released when said thrust means are in the actuation position and said locking elements of said thrust member escape from said notches of the barrel.

23. An actuator according to claim 19, wherein said piston includes a hollow of conical or frustoconical shape in its base communicating with said bore pierced along the thrust shaft of said piston.

24. A device adapted in particular for transporting fluids and powder materials, the device comprising a pipe according to claim 1 together with at least one actuator for actuating said clamping device of said pipe and suitable for exerting a said determined stress on said clamping means of said clamping device to stiffen said pipe.

25. A device according to claim 24, including at least one individual said actuator, in particular a said traction means, for each of said cables of said clamping means of said clamping device of said pipe.

26. A device according to claim 24, including an actuator according to claim 13.

27. The use of a pipe according to claim 1, wherein initially said pipe is connected to an actuator, in particular an actuator according to claim 13, in such a manner that said clamping means of said clamping device co-operate with said control and actuator means, and then said flexible pipe is placed in a position that is determined as a function of the particular use of the pipe, and then the actuator is activated to apply a determined stress to said clamping means causing said pipe to be stiffened and frozen in said determined position in which it has been placed.
